(19) United States
(12) Patent Application Publication
(10) Pub. No.: US 2010/0107081 A1
(43) Pub. Date: Apr. 29, 2010

(54) PROJECTION DEVICE IMAGE VIEWER USER INTERFACE

(75) Inventor: Alexander Benenson, Salem, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: INFOCUS CORPORATION, Wilsonville, OR (US)

(21) Appl. No.: 12/258,270

(22) Filed: Oct. 24, 2008

(51) Int. Cl. G06F 3/048

(52) U.S. Cl. 715/730

(57) ABSTRACT

A projection device configured to removably receive a portable data storage device having a plurality of files stored thereon, including: projection electronics to generate a projected image, an image viewer source operatively coupled to the projection electronics, and computer-readable data storage having instructions therein that when executed by the image viewer source: identify files that are displayable by the projection device from the plurality of files stored on the portable data storage device; and generate a projectable user interface to view at least one identified file, the projectable user interface having a thumbnail view including a list of folder thumbnails representative of folders containing displayable files stored on the portable data storage device and image thumbnails representative of displayable files stored on the portable data storage device, and a slideshow view including a full-sized image of a specified image thumbnail.

### BACKGROUND

Multimedia projection devices have become popular for purposes such as conducting sales demonstrations, business meetings, classroom training, and for use in home theaters. Typically, in such a setting a projection device is connected to a computing device or other external computing source (e.g., a digital video disc (DVD) player) that may execute a software application to provide multimedia content to the projection device as well as to control presentation of the multimedia content. This type of presentation arrangement may have several shortcomings.

In particular, in order to display multimedia content, a computing device may have to be connected to the projection device to provide multimedia content and presentation control. This may result in time being spent to repeatedly connect and configure the computing device to interact with the projection device. On the other hand, a computing device may be connected to the projection device permanently or for a long duration. This permanent arrangement may create a larger spatial footprint as well as a restriction on placement of the projection device in the presentation setting.

What is needed is a simple way to present multimedia content utilizing a projection device that reduces the complexity, space, cost, and inefficiency of presenting multimedia content by connecting a projection device to an external computing device.

### SUMMARY

A projection device configured to removably receive a portable data storage device having a plurality of files stored thereon, including: projection electronics to generate a projected image, an image viewer source operatively coupled to the projection electronics, and computer-readable data storage having instructions therein that when executed by the image viewer source: identify files that are displayable by the projection device from the plurality of files stored on the portable data storage device; and generate a projectable user interface to view at least one identified file, the projectable user interface having a thumbnail view including a list of folder thumbnails representative of folders containing displayable files stored on the portable data storage device and image thumbnails representative of displayable files stored on the portable data storage device, and a slideshow view including a full-sized image of a specified image thumbnail.

This Summary is provided to introduce concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an exemplary image display system of the present disclosure.

FIG. 2 schematically shows the computer architecture of a portable data storage device and a projection device of the image display system of FIG. 1.

FIG. 3 shows a flow diagram of an exemplary method for presenting a user interface to display image files transferred from the portable data storage device to the projection device.

FIG. 4 shows a state diagram of a user interface that may be generated by an image viewer of the projection device to navigate to and view images.

FIG. 5 shows a no-image view of a graphical user interface that may be generated by the image viewer and projected by the projection device.

FIG. 6 shows a thumbnail view of a graphical user interface that may be generated by the image viewer and projected by the projection device.

FIG. 7 shows a slideshow view of a graphical user interface that may be generated by the image viewer and projected by the projection device.

FIG. 8 shows an image-viewer-specific menu view of a graphical user interface that may be generated by the image viewer and projected by the projection device.

### DETAILED DESCRIPTION

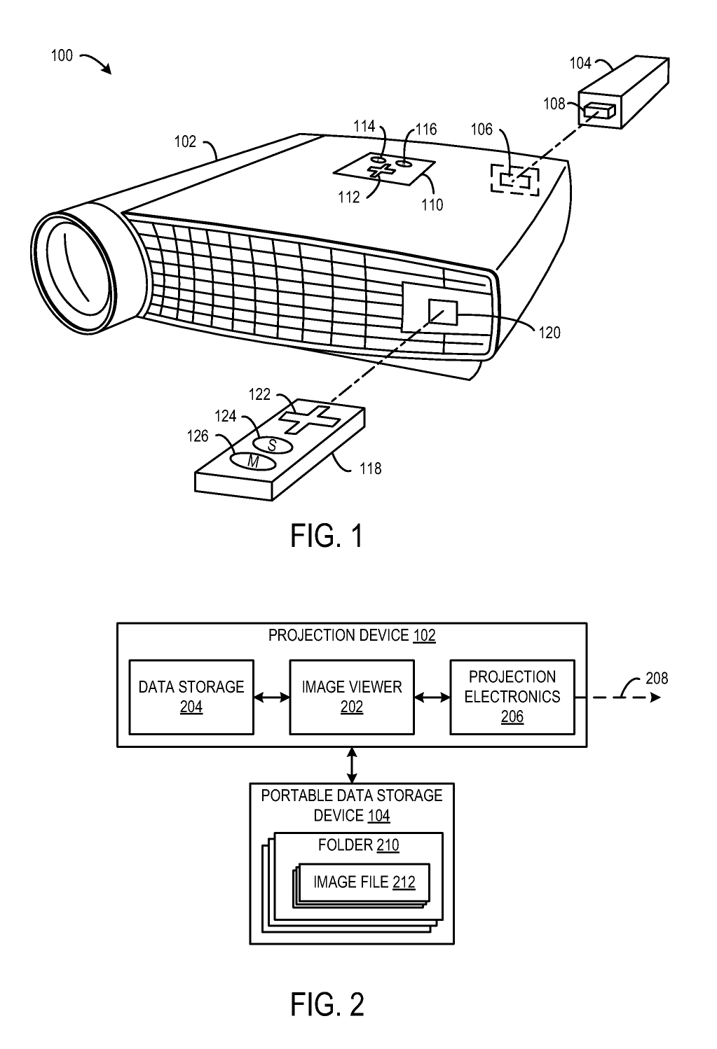

FIG. 1 shows an image display system 100. Image display system 100 typically includes a projection device 102. Projection device 102 may be virtually any suitable display device, including, but not limited to, a front projection device that projects an image onto a remote display, or a rear projection device that projects an image onto a display integrated into the projection device. A portable data storage device 104 may be configured to be operatively coupled to, or otherwise operatively associated with, projection device 102. Portable data storage device 104 may be virtually any suitable storage device including, but not limited to, a flash memory device, a hard drive, etc. Projection device 102 may include an outlet 106 configured to removably receive plug 108 of portable data storage device 104. The interconnection of plug 108 into outlet 106 may permit portable data storage device 104 to directly engage or plug into projection device 102. In one example, outlet 106 is a Universal Serial Bus (USB) port. Plug 108 may be inserted into the USB port to permit file transfer to be performed between the portable data storage device and the projection device. It will be appreciated that other connection and data transfer protocols may be implemented.

In some embodiments, attachment structures, such as latches, projections, pins, tabs, braces, screws or other suitable supports, may be used to retain portable data storage device 104 in projection device 102. Alternatively, instead of an integral connection, portable data storage device 104 may be attached to projection device 102 via a cable and suitable plug.

Projection device 102 includes a control panel 110 positioned on a top surface of projection device 102. Control panel 110 may be used to control operation of projection device 102 and, more particularly, to control presentation of images presented by projection device 102. Control panel 110 may include a directional pad 112 which includes directional buttons which may be used to navigate up, down, right (forward), or left (back). In some embodiments, instead of a directional pad, navigation may be performed via a joystick, touchpad, or another input device. Control panel 110 may include a select button 114 that may be utilized to initiate a variety of different projection functions, such as selecting an image for viewing, selecting a folder to browse, selecting a menu setting, etc. Control panel 110 may include a menu button 116 that may be utilized to toggle display of an image-viewer-specific menu. During display of the image-viewer-specific menu, directional pad 112 and/or select button 114 may be used to change image presentation settings and/or slideshow presentation settings of the image-viewer-specific menu. It will be appreciated that the control panel may include other inputs. For example, the control panel may include a power button, a projection menu button, or virtually any other suitable input to control projection device operation.

Projection device 102 may be configured to be controlled remotely. In particular, remote control device 118 may be configured to send signals to control user interface navigation and/or image presentation to a receiver 120 of projection device 102. Remote control device 118 may interact with receiver 120 in virtually any suitable manner of wireless communication, such as infrared (IR), radio (e.g., 802.11 protocol), etc. Remote control device 118 may include similar user inputs as control panel 110 that provide substantially the same functionality. In particular, remote control device 118 may include directional pad 122, select button 124, and menu button 126. In some embodiments, remote control of the projection device may be performed by a wired network-based remote control or network-based computing device in communication with the projection device.

FIG. 2 schematically shows the computer architecture of projection device 102 and portable data storage device 104. Portable data storage device 104 may include one or more image file(s) 212 stored thereon. The image file(s) 212 may be organized in folder(s) 210 that further may be organized according to a file hierarchy. Image file(s) 212 may be stored according to virtually any suitable file type, such as JPEG, TIFF, BMP, etc. Further, portable data storage device 104 may include files other than image files displayable by projection device 102, such as fixed-document files (e.g., PDF, XPS, etc.) or text and document files, for example. When portable data storage device 104 is in electronic communication with projection device 102, image file(s) 212 may be transferred to projection device 102 for presentation.

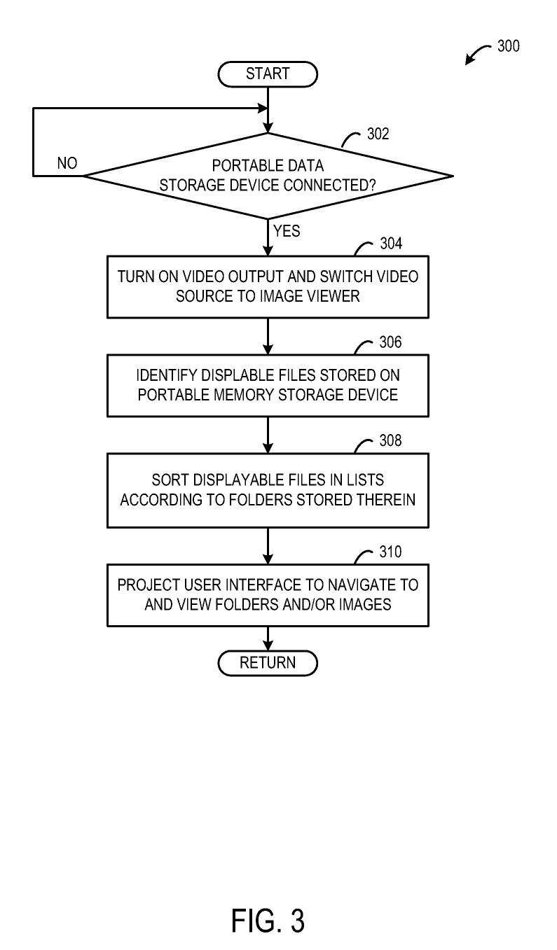

Projection device 102 may include an image viewer 202 to generate a user interface for displaying image files from portable data storage device 104. In particular, image viewer 202 may identify image files or other displayable files stored on portable data storage device 104. Data storage 204 may include processing instructions for identifying files on portable data storage device 104 as well as processing instructions for generating a user interface to navigate to and project the identified image files for viewing. Data storage 204 may be virtually any suitable storage device, such as flash memory, hard drive, random access memory (RAM), etc. Methods for image file transfer and presentation by the projection device will be discussed in further detail below with reference to FIG. 3

Image viewer 202 may be an internal video source to which projection device 102 may switch to project images for viewing. Since image viewer 202 is integral to projection device 102, projection device need not be connected to an external video source (e.g., a personal or laptop computer) or have an additional optical drive (e.g., a DVD drive) to display images. In some embodiments, image viewer 202 may be an application program stored on data storage 204 and executable by a primary processing unit of projection device 102. In some embodiments, image viewer 202 may include a processing subsystem that is designated specifically for operations related to image file transfer, conversion, and/or display. Further, it will be appreciated that image viewer 202 may be implemented as software, hardware, firmware, or a combination thereof.

Image viewer 202 may be operatively coupled to, or in electronic communication with, projection electronics 206. Projection electronics 206 may receive image data from image viewer 202 and may process the image data to generate a projected image 208. In one example, projection electronics 206 includes a light source (e.g., a lamp) that directs light through an image generation device (e.g., a light valve, a digital micromirror device (DMD), etc.). The image generation device utilizes the image data received from image viewer 202 to manipulate the light from the light source to form an image. Once formed, the image is routed through optics (e.g., lens) so that the image is suitable for projection.

FIG. 3 shows a flow diagram of an example method 300 for presenting a user interface to display image files transferred from a portable data storage device operatively coupled to the projection device. In one example, the image viewer source, integral to the projection device, performs the method to generate the user interface. The method begins at 302, where the method may include determining if a portable data storage device is connected to the projection device. If it is determined that a portable data storage device is connected to the projection device, the method moves to 304. Otherwise, connection of a portable data storage device with the projection device is not detected and the method continues to poll for connection of a portable data storage device. In some embodiments, detection of a portable data storage device may be interrupt driven such that a notification is generated only when the portable data storage device is initially connected.

At 304, the method may include turning on a video output of the projection device and switching the video source of the projection device to the image viewer. In some embodiments, the video source may be selectively switched to the image viewer source based on a state of a presentation setting of the image-viewer-specific menu being turned on.

At 306, the method may include identifying files displayable by the projection device stored on a portable data storage device connected to the projection device. In particular, the portable data storage device may be searched for file types designated to be image files, fixed-document files, document files, or the like. As such, in some cases, a plurality of different file types may be identified as displayable files. In one example, the image viewer iteratively scans the folders stored on portable data storage device and identifies each displayable file in each folder. In some embodiments, all identified files are converted to image files that may be adapted for display by the projection device. For example, a fixed-document file may be converted into a bitmap image file that may be sized to fit the displayable area projected by the projection device.

At 308, the method may include sorting the displayable files in lists according to the folders in which the files were identified on the portable data storage device. In some cases, the list in each folder may be sorted in alphabetic order. In some cases, the list in each folder may be sorted according to the order in which the files were identified. In some embodiments, the displayable files may be stored on portable data storage device 104. In some embodiments, the converted files may be stored on data storage 204. In some embodiments, storing the converted files may be omitted in favor of “on the fly” file conversion for presentation, in which image data from portable data storage device 104 may be streamed to image viewer 202 and displayed by projection device 102. In some embodiments, the displayable files may be sorted into a single-level list that ignores file hierarchy. In some cases, the list may be sorted in alphabetic order.

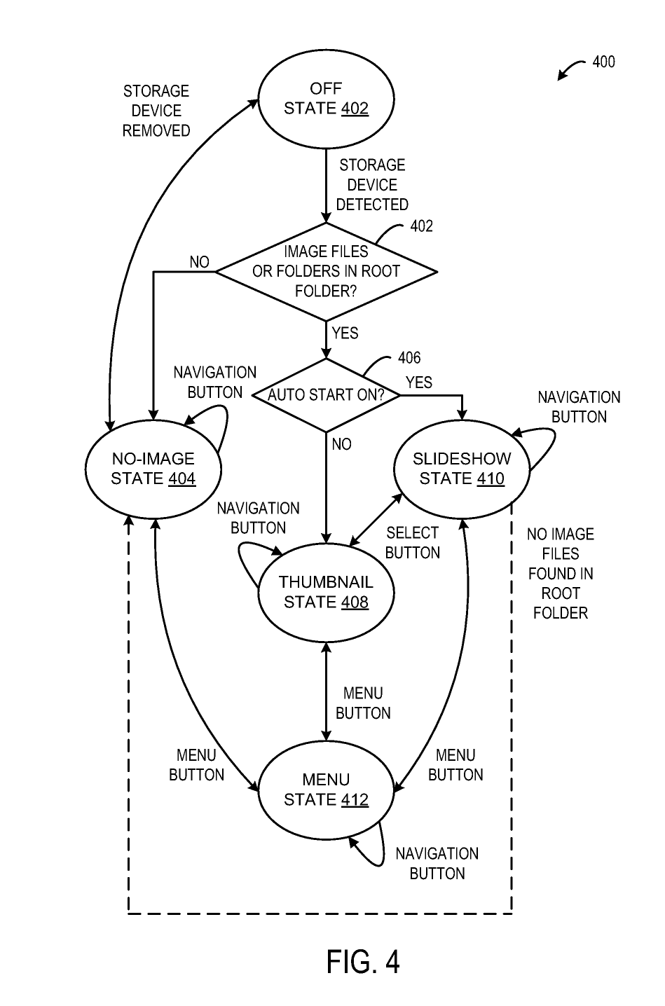

At 310, the method may include projecting a user interface to navigate to and view folders and/or converted image files so that the images may be displayed by the projection device. The states or views of the user interface will be described in further detail below with reference to FIGS. 4-8.

The above described method may facilitate viewing of images from a portable data storage device by a projection device in a quick and simple manner that bypasses external video sources and/or software applications which may increase the complexity of a projection system beyond that of a projection device.

FIG. 4 shows a state diagram 400 of a user interface that may be generated by image viewer 202 of projection device 102 to navigate to and view images. State diagram 400 may include an off state 402. In this state, the source output of image viewer 202 is turned off and no image data is provided by image viewer 202 to projection electronics 206. Image viewer 202 may be in off state 402 when no connection of a portable data storage device to the projection device is detected. It will be appreciated that off state 402 may enable projection device 102 to skip image viewer 202 as a source when the projection device is searching for a source to display. If projection device 102 detects connection of a portable data storage device to the projection device, image viewer 202 moves from off state 402 to 404.

At 404, projection device 102 may switch sources to image viewer 202 to initiate searching portable data storage device 104 for image files or folders on portable data storage device 104. If no image files are found on portable data storage device 104 by image viewer 202, image viewer 202 moves to no-image state 404. If image files are found on portable data storage device 104 image viewer moves to 406.

At 406, if image files or folders are found on portable data storage device 104 and an auto start setting of the image-viewer-specific menu is set to “ON”, image viewer 202 moves to slideshow state 410. Otherwise, image files or folders are found on the portable data storage device 104 and the auto start setting is set to “OFF”, image viewer 202 moves to thumbnail state 408.

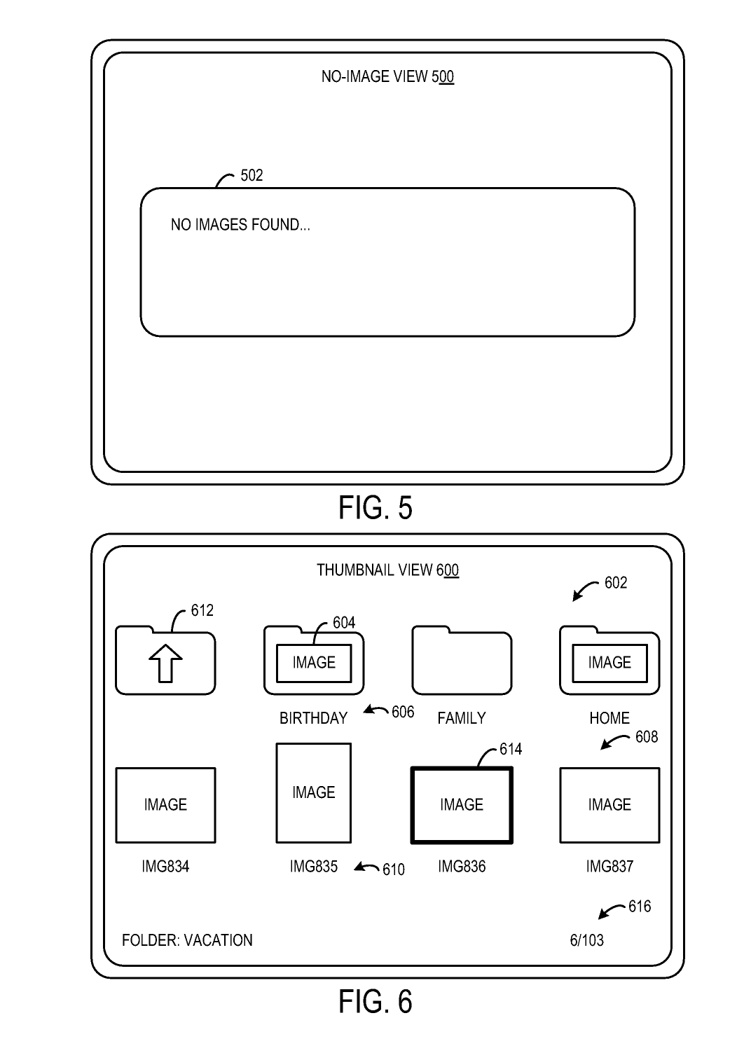

Upon entering no-image state 404, no-image view 500 (See FIG. 5) may be displayed by projection device 102. No-image state 404 may provide an indication that no images were found on portable data storage device 104. Image viewer 202 may remain in no-image state 404 until portable data storage device 104 is removed from projection device 102 at which time image viewer 202 moves to off state 402. If image viewer 202 receives an input signal indicative of activation of image-viewer-specific menu button 116/126, image viewer 202 moves from no-image state 404 to menu state 412.

Upon entering thumbnail state 408, thumbnail view 600 (See FIG. 6) may be displayed by projection device 102. In thumbnail view 600, a list of all image files (or displayable files) and all folders having image files identified on portable data storage device 104 may be presented. The list may be organized into a folder hierarchy that initially presents the image files and folders in the root folder of portable data storage device 104. The file hierarchy and list may be navigated utilizing the navigation buttons of directional pad 112,124 and select button 114,124. Each image file in the list may be represented by an image thumbnail icon. Each folder in the list may be represented by a folder thumbnail icon having an image thumbnail representative of the first image file listed in that folder. If a folder does not contain an image file, no image thumbnail is presented in the folder thumbnail of that folder. If a folder has no image files and no child folder of that folder has no image files, the folder may be omitted or selectively displayed based on a state of a presentation setting of the image-viewer-specific menu.

A selection of the list may be highlighted to indicate a cursor for navigating the image thumbnails and folder thumbnails in thumbnail view 600.lf image viewer 202 receives an input signal indicative of activation of select button 114,124 to select a particular image thumbnail or folder thumbnail, image viewer 202 moves from thumbnail state 408 to slideshow state 410. If image viewer 202 receives an input signal indicative of activation of select button 114,124 to select an “UP” icon of thumbnail view 600, image viewer 202 navigates the file hierarchy to the parent folder. The “UP” icon is only displayed in folders contained in a parent folder (i.e., all folders but the root folder of portable data storage device 104). If image viewer 202 receives an input signal indicative of activation of a specified direction of directional pad 112, the cursor moves in the specified direction to the next image/folder thumbnail and image viewer 202 remains in thumbnail state 408. If image viewer 202 receives an input signal indicative of activation of menu button 116/126, image viewer 202 moves from thumbnail state 408 to menu state 412.

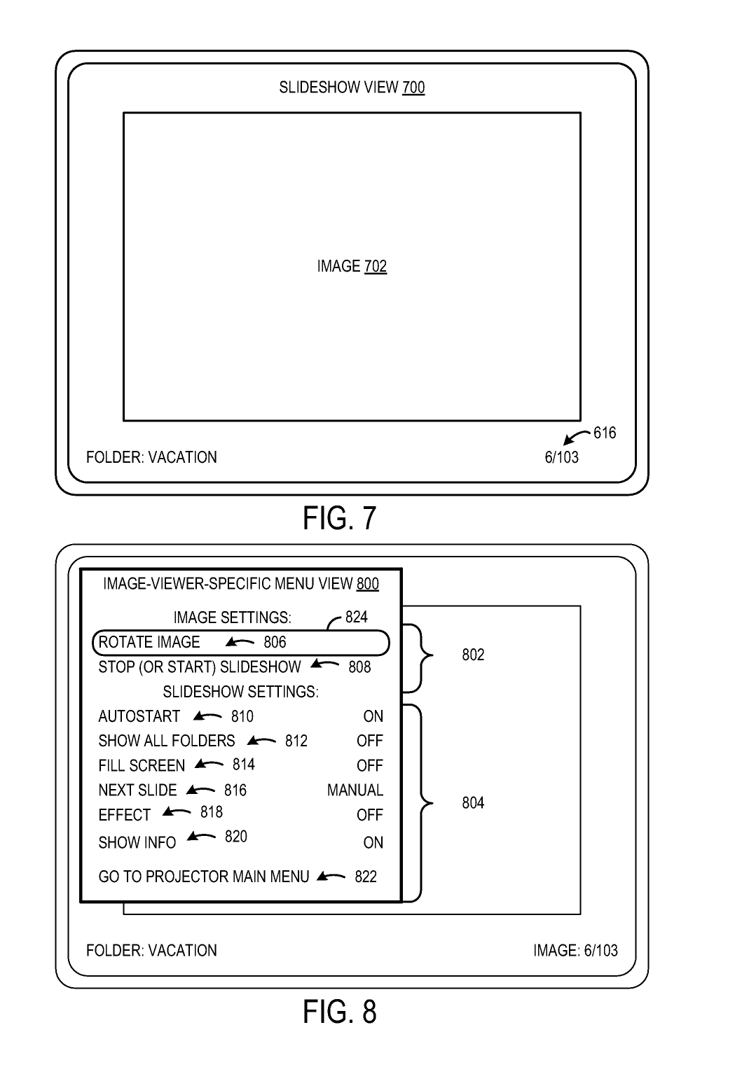

Upon entering slideshow state 410, slideshow view 700 (See FIG. 7) may be displayed by projection device 102. In slideshow view 700, a full-sized image of the selected image thumbnail may be presented. In some cases, the full-sized image is substantially display sized. In some cases, when in slideshow state 410, image viewer 202 may present each image thumbnail in the currently selected folder. In some cases, image viewer 202 may present each image thumbnail of all folders identified by image viewer 202. In some cases, image viewer 202 may present only the selected image thumbnail. Each of the above cases may be dictated by a state of a presentation setting of the image-viewer-specific menu.

During slideshow state 410, image viewer 202 may repeat presentation of the selected image(s) until image viewer 202 receives an input signal indication of activation of select button 114,124. Slideshow state 410 may pause presentation of the current image while the image-viewer-specific menu or the projection device menu is visible. If image viewer 202 receives an input signal indicative of activation of select button 114,124, image viewer 202 moves from slideshow state 410 to thumbnail state 408. If image viewer 202 receives an input signal indicative of activation of a specified direction of directional pad 112, the next/previous image in the list may be displayed and image viewer 202 remains in slideshow state 410. If image viewer 202 receives an input signal indicative of activation of image-viewer-specific menu button 116/126, image viewer 202 moves from slideshow state 410 to menu state 412. In some cases, image viewer 202 may transition from slideshow state 410 to no-image state 404. For example, upon initial detection of a folder in the root folder of a portable data storage device and the auto start setting being “ON”, the image viewer moves to slideshow state 410. If a search of the folders of the portable data storage device does not identify and displayable files, the image viewer moves from slideshow state 410 to no-image state 404.

Upon entering menu state 412, menu view 800 (See FIG. 8) may be displayed by projection device 102. In menu view 800, an image-viewer-specific menu may be presented over the currently displayed view of the user interface generated by image viewer 202. The image-viewer-specific menu may include image-presentation settings and slideshow-presentation settings. If image viewer 202 receives an input signal indicative of activation of menu button 116/126, image viewer 202 moves from menu state 412 to the previous state displayed under the image-viewer-specific menu.

It will be appreciated that each of the above described states of image viewer 202 may cause a different view of a user interface generated by image viewer 202 to be projected by projection device 102 to facilitate a user to navigate to and view images projected by projection device 102. Exemplary views of the user interface generated by image viewer 202 will be described in further detail below with reference to FIGS. 5-8.

FIG. 5 shows a no-image view 500 of a graphical user interface that may be generated by image viewer 202 and projected by projection device 102 upon entering no-image state 404. In particular, no-image view 500 may be projected in response to detection of no image files stored on the portable data storage device. No-image view 500 may include a no-image indicator 502 to point out to a user that no images were found on the portable data storage device. In one example, no-image indicator 502 is a textual message, such as “NO IMAGES FOUND” It will be appreciated that no-image view 500 may be generated by hardware of projection device 102, more particularly, image viewer 202 as opposed to software executable on a computing device in electronic communication with projection device 102.

FIG. 6 shows a thumbnail view 600 of a graphical user interface that may be generated by image viewer 202 and projected by projection device 102 upon entering thumbnail state 408. Thumbnail view 600 may include a plurality of folder thumbnails 602 representative of each folder having image files stored therein or having a child folder having an image file stored therein on portable data storage device 104. Each folder of the plurality of folder thumbnails 602 having an image file may include an image thumbnail 604 representative of a first image file found in that folder. Each of the plurality of folder thumbnails 602 may include a folder title 606 to describe the contents of the folder. The plurality of folder thumbnails 602 may be organized according to a list within the file hierarchy of portable data storage device 104, as discussed above. In some cases, the list may be sorted in alphabetical order according to folder title 606 of each of the plurality of folder thumbnails 602. Folder title 606 may be truncated with an ellipsis in the case that the title is above a predetermined number of characters.

Thumbnail view 600 may include a plurality of image thumbnails 608 representative of image files stored on portable data storage device 104. Each of the plurality of image thumbnails 608 may include an image title 610 that describes the image file. The plurality of image thumbnails 608 may be interspersed with the plurality of image thumbnails 608 or may be organized according to a single-level list. In some cases, the single-level list may be sorted in alphabetical order according to image title 610 of each of the plurality of image thumbnails 608. Image title 610 may be truncated with an ellipsis in the case that the title is above a predetermined number of characters. Each of the plurality of image thumbnails 608 may be vertically or horizontally presented according to the original alignment of the image.

Thumbnail view 600 may include an “UP” icon 612 positioned in the upper-left region of thumbnail view 600. Selection of “UP” icon 612 via input select button 114,124 may cause image viewer 202 to navigate to a parent folder of the currently displayed folder. In the case that the currently displayed folder is the root folder of the portable data storage device, “UP” icon 612 is not displayed because the root folder does not have a parent folder. In the illustrated embodiment, “UP” icon 612 is represented by a folder having an arrow pointed upward.

Thumbnail view 600 may include cursor 614 that may highlight a current folder thumbnail or image thumbnail for selection. Curse 614 may be utilized as a visual cue for navigation of various selections presented in the user interface. In the illustrated embodiment, cursor 614 is a bolded or broad outline indicating a currently highlighted image thumbnail. It will be appreciated that cursor 614 may be depicted by virtually any suitable representation to highlight a folder thumbnail, image thumbnail, or “UP” thumbnail.

Thumbnail view 600 may include a selection indicator 616 to display selection information. For example, selection indicator 616 may include a number of a currently highlighted selection. The number may be one out of a sequence of folders and images in the current list of the file hierarchy (or the entire file hierarchy). In some embodiments, selection indicator 616 may include a title of a current selection and/or a folder in which the current selection is stored. Selection indicator 616 may be selectively displayed based on a state of a presentation setting of the image-viewer-specific menu.

In order to maintain clear visibility of image thumbnail 604 and the plurality of image thumbnails 608 to facilitate recognition of the image thumbnails of each of the plurality of folder thumbnails 602, a predetermined number of image and folder thumbnails may be displayed in thumbnail view 600 at one time. For example, a total of fifty folders having image files may be stored on a portable data storage device. Thumbnail view 600 may only display eight of the fifty folder thumbnails at one time so that the size of the folder thumbnails and more particularly, the image thumbnails may be large enough to be recognized for selection. Input from directional pad 112,122 may be used to navigate to additional folder thumbnails to shift them into thumbnail view 600.

FIG. 7 shows a slideshow view 700 of a graphical user interface that may be generated by image viewer 202 and projected by projection device 102 upon entering slideshow state 410. Slideshow view 700 may include image 702 that has been selected for display. Image 702 may be a full-sized image of the specified image thumbnail. Image 702 may be sized to substantially fill the display screen or may be sized smaller according to the original size of image 702 based on the state of a fill-screen setting of the image-viewer-specific menu. In both cases the aspect ratio of the displayed image may be protected, as such black sidebars may be included in the background to fill out the displayed area.

Image 702 may be static or may transition to each image thumbnail in the currently specified folder to display a slideshow based on a state of a play-all-images setting of the image-viewer-specific-menu. The slideshow may repeat continuously until input is received to return to thumbnail state 408. A transition effect may be performed when transitioning between images based on a state of an effect setting of the image-viewer-specific menu. Further, “UP” or “DOWN” input from directional pad 112,122 may result in switching displayed images without performing a transition effect.

It will be appreciated that a slideshow may be paused while the image-viewer-specific menu view is displayed or when the projection device projection source is switched to a different display source from the image viewer. Further, it will be appreciated that selection indicator 616 may be selectively displayed in slideshow view 700 based on a state of a presentation setting of the image-viewer-specific menu.

FIG. 8 shows an image-viewer-specific menu view 800 of a graphical user interface that may be generated by image viewer 202 and projected by projection device 102 upon entering menu state 412. Image-viewer-specific menu view 800 may be overlaid on any view of the graphical user interface generated by image viewer 202 currently projected by projection device 102 in response to a signal indicative of input from menu button 116/126. Image-viewer-specific menu view 800 may include image presentation settings 802 and slideshow presentation settings 804.

Image presentation settings 802 may include a rotate-image setting 806 that may be selected to rotate a currently displayed image. For example, the rotate image setting may rotate a displayed image clockwise ninety degrees. Image presentation settings 802 may include start/stop slideshow setting 808 that may be toggled to show individually selected images or to show a slideshow of all images in a specified folder.

Slideshow presentation settings 804 may include auto-start setting 810 that may be toggled to automatically start a slideshow responsive to connection of portable data storage device 104 with projection device 102. In particular, if auto-start setting 810 is in an “ON” state, image viewer 202 may be automatically made the active projection source and may start in slideshow state 410 to generate slideshow view 700 showing the first image found. If auto-start setting 810 is in an “OFF” state, a user may manually switch the projection source to image viewer 202. Further, image viewer 202 starts in thumbnail state 408 to generate thumbnail view 600.

Slideshow presentation settings 804 may include a show-all-folders setting 812 that may be toggled to display all images in all folders of a portable data storage device during a slideshow, or to display images of only a specified folder during a slideshow. If the show-all-folders setting is in an “ON” state, the slideshow presentation may be ordered alphabetically for the current folder followed by the remaining images in the other folders.

Slideshow presentation settings 804 may include a full-screen setting 814, the value of which may be toggled to manipulate the size of the currently displayed image between a full screen size and a smaller size based on the original dimensions of the image. It will be appreciated that regardless of the state of full-screen setting 814, if an image is sized larger than the display screen size, the image is resized by image viewer 202 to fit in the display screen while preserving the aspect ratio of the image.

Slideshow presentation setting 804 may include a next-slide setting 816 the value of which may be switched to change the amount of time an image is display before transitioning to the next slide in the slideshow. For example, next slide setting 816 may be switched between manual, three seconds, ten seconds, thirty seconds, and one minute states. In the manual state, transitioning between slides may be performed based on input from directional pad 112,122. Note input from directional pad 112,122 may be used to switch between images in the other states prior to the set time to transition.

Slideshow presentation settings 804 may include an effects setting 818 the value of which may be switched to change the type of visual transition performed when switching images. For example, effects setting 818 may be switched between off (default), a random effect, a fade effect, a star-wipe effect, a spiral effect, etc.

Slide show presentation settings 804 may include a show-info setting 820 that may be toggled to show or hide information about a selection (i.e., image or folder), such as selection indicator 616, for example. Slideshow presentation settings 804 may include a go-to-main-menu setting 822 that may be selected to display the main menu of projection device 102 to control projection device operation.

It will be appreciated that image-viewer-specific menu view 800 may be generated by hardware or firmware of projection device 102, more particularly, image viewer 202 as opposed to a software application executable by a computing device in communication with projection device 102. However, image viewer 202 may generate image-viewer-specific menu view 800 according to settings of the main menu of projection device 102. In particular, image viewer 202 may generate image-viewer-specific menu view 800 in a language currently selected for the main menu. Accordingly, when switching states, image viewer 202 may query projection device 102 for the language currently selected for use in the main menu. Additional characteristics of the main menu may be utilized to generate image-viewer-specific menu view 800, such as for example, fonts, themes, colors, etc. In this way, the graphical user interface generated by image viewer 202 may support different languages and styles that correspond to that of other presentation characteristics of projection device 102.

Each of the settings of the image-viewer-specific menu may be selected for adjustment via menu cursor 824. In the illustrated embodiment, menu cursor 824 is a bold oval ring that surrounds a highlighted setting. Menu cursor 824 may be moved around the menu via signals from directional pad 112,122. Further, states of each setting may be changed via signals from select button 114,124.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. In a projection device configured to removably receive a portable data storage device having a plurality of image files stored thereon, a method of presenting a user interface for displaying at least one of the plurality of image files via an image viewer source integral to the projection device, the method comprising:
in response to detection of an image file stored on a portable data storage device upon the storage device being operatively coupled to the projection device, projecting a thumbnail view of the user interface including folder thumbnails representative of folders stored on the portable data storage device and image thumbnails representative of image files stored on the portable data storage device and folder; and
projecting a slideshow view of the user interface in response to receiving user input selecting a specified image thumbnail, the slideshow view including a full-sized image of the specified image thumbnail.

2. The method of claim 1, further comprising:
projecting an image-viewer-specific menu of the user interface in response to receiving user input selecting the image viewer specific menu, the image-viewer-specific menu including image presentation settings and slideshow presentation settings.

3. The method of claim 2, wherein presentation of the image-viewer-specific menu is overlaid on a view of the user interface currently projected by the projection device.

4. The method of claim 2, further comprising:
projecting the slideshow view instead of the thumbnail view upon detection of an image file stored on the portable data storage device based upon an auto start setting of the image-viewer-specific menu being in an on state.

5. The method of claim 1, further comprising:
projecting a no-image view of the user interface in response to detection of no image files stored on the portable data storage device.

6. The method of claim 1, wherein the thumbnail view does not include folder thumbnails representative of folder stored on the portable data storage device having no image files or folders.

7. The method of claim 1, wherein the image thumbnails and the folder thumbnails are presented in a list that is ordered alphabetically.

8. The method of claim 1, wherein each folder thumbnail representative of a folder having at least one image file includes an image thumbnail representative of a first image file found in that folder.

9. The method of claim 8, wherein a predetermined number of image thumbnails and/or folder thumbnails are displayed in the thumbnail view at one time.

10. The method of claim 1, wherein the thumbnail view of a specified child folder includes an icon selectable to project a thumbnail view of a parent folder.

11. The method of claim 1, wherein the thumbnail view includes a total number of image thumbnails and folder thumbnails stored in a specified folder.

12. A projection device configured to removably receive a portable data storage device having a plurality of files stored thereon, comprising:
projection electronics to generate a projected image;
an image viewer source operatively coupled to the projection electronics; and
computer-readable data storage having instructions therein that when executed by the image viewer source:
identify files that are displayable by the projection device from the plurality of files stored on the portable data storage device; and
generate a projectable user interface to view at least one identified file, the projectable user interface having a thumbnail view including a list of folder thumbnails representative of folders containing displayable files stored on the portable data storage device and image thumbnails representative of displayable files stored on the portable data storage device, and a slideshow view including a full-sized image of a specified image thumbnail.

13. The projection device of claim 12, wherein the projectable user interface further includes an image-viewer-specific menu displayed in response to receiving user input selecting the image viewer specific menu, the image viewer specific menu including image presentation settings and slideshow presentation settings.

14. The projection device of claim 13, wherein the image-viewer-specific menu is overlaid on a currently displayed view of the projectable user interface when displayed.

15. The projection device of claim 12, wherein the portable data storage device operatively couples to the projection device via a universal serial bus type connection.

16. The projection device of claim 12, wherein the slideshow view includes a name of a folder in which the specified image thumbnail is stored, and a number of the specified image thumbnail in a sequence of image thumbnails stored in the folder.

17. The projection device of claim 12, wherein the files displayable by the image viewer source include image files, fixed-document files, and document files.

18. In a projection device configured to removably receive a portable data storage device having a plurality of image files stored thereon, a method of presenting a user interface for displaying at least one of the plurality of image files via an image viewer source integral to the projection device, the method comprising:
in response to detection of an image file stored on a portable data storage device upon the storage device being operatively coupled to the projection device, projecting a thumbnail view of the user interface including folder thumbnails representative of folders stored on the portable data storage device and image thumbnails representative of image files stored on the portable data storage device and folder;
projecting a slideshow view of the user interface in response to receiving user input selecting a specified image thumbnail, the slideshow view including a full-sized image of the specified image thumbnail; and
projecting an image-viewer-specific menu of the user interface in response to receiving user input selecting the image viewer specific menu, the image viewer specific menu including image presentation settings and slideshow presentation settings.

19. The method of claim 18, wherein text of the image-viewer-specific menu is displayed in a language corresponding to a selected language of a main menu of the projection device.

20. The method of claim 18, wherein the slideshow presentation settings are selected from the group consisting of an auto-start setting, a show all folders setting, a fill screen setting, a next slide setting, an effects setting, and a show information setting.
